(19) United States
(12) Patent Application Publication
(10) Pub. No.: US 2016/0358390 A1
(43) Pub. Date: Dec. 8, 2016

(54) ELECTRIC LOCK CONTROL DEVICE

(71) Applicant: ALPHA CORPORATION, Yokohama-shi (JP)

(72) Inventor: Shingo IMADA, Yokohama-shi (JP)

(21) Appl. No.: 15/240,322

(22) Filed: Aug. 18, 2016

Related U.S. Application Data
(63) Continuation of application No. PCT/JP2015/054689, filed on Feb. 19, 2015.

(30) Foreign Application Priority Data
Feb. 19, 2014 (JP) 2014-029204

(51) Int. Cl. G07C 9/00

(52) U.S. Cl. CPC G07C 9/0069

(57) ABSTRACT

An electric lock control device is provided with a password code input section in which different codes for password are disposed in an arrangement set in advance, a password code authentication section in which an authentication establishment condition is that an input code string input from the password code input section coincides with a pre-registered password code string for authentication, a dummy input detecting section which detects an input of an arbitrary code for password to the password code input section after a main authentication operation in the password code authentication section, and a controller which drives an electric lock to unlock in a condition detecting an input of a code for password in the dummy input detecting section in addition to the authentication establishment at the time of the main authentication operation.

### CROSS REFERENCE TO RELATED APPLICATIONS

This application is a continuation of PCT application No. PCT/JP2015/054689, which was filed on Feb. 19, 2015 based on Japanese Patent Application (No. 2014-029204) filed on Feb. 19, 2014, the contents of which are incorporated herein by reference.

### BACKGROUND OF THE INVENTION

Field of the Invention

The present disclosure relates to an electric lock control device.

Description of Related Art

Patent literature 1 discloses an electric lock control device which controls locking and unlocking of an electric lock.

The electric lock control device of patent literature 1 includes a password code input board that is provided with a number display section, which is capable of selectively displaying numbers set in each displaying area, and a controller, which displays arbitrary numbers before inputting a password code, displays the entirety of the numbers in the displaying area at the time of finishing a switching motion with the numbers, and then is used to be capable of inputting the password code.

In the electric lock control device of patent literature 1, since dummy input is urged before inputting the password code, there is an advantage that other people cannot easily find out the password code during inputting. Meanwhile, in a password code input board, a fingerprint, or the like is attached to the displaying area, where numbers which are finally operated, that is, the password code is allocated. For this reason, there is a concern that the password code can be known by other people when they monitor the displaying area after operating.

In addition, while only numbers which need to be operated are displayed, when performing the dummy input, the entirety of the board is displayed when inputting the password code. Therefore, since an input timing of the password code can be determined according to brightness of a surface of the board, protection of the password code by the dummy input is also not expected much.

### CITATION LIST

### Patent Literature

[Patent Literature 1] JP-B2-4884879

The present disclosure relates to an electric lock control device which is capable of reliably preventing a leak of a password code when inputting the password code.

### BRIEF DESCRIPTION OF THE DRAWINGS

FIG. 1A is a front view of an electric lock control device. FIG. 1B is a side view of the electric lock control device. FIG. 1C is a perspective view illustrating a state in which the electric lock control device is fixed to a door.

FIG. 2A is a view illustrating a state in which all codes of a password code input section and marks are displayed. FIG. 2B is a view illustrating a state of a main authentication operation of a password code input section. FIG. 2C is a view illustrating the password code input section at the time of a dummy input. FIG. 2D is a view illustrating an unlocking completion state of the password code input section. FIG. 2E is a view illustrating an authentication mode by an authentication medium of the password code input section.

FIG. 3 is a function block diagram of an electric lock control device.

FIG. 4 is a flow chart illustrating a motion of the electric lock control device.

FIG. 5 is a flow chart of a password number authentication step.

FIG. 6 is a flow chart of the password number authentication step.

FIG. 7 is a flow chart of a card authentication step.

FIG. 8 is a flow chart of a management step.

FIG. 9 is a flow chart of a processing step after deleting an ID.

FIG. 10 is a flow chart of a processing step after deleting a user card.

FIG. 11 is a flow chart of a processing step after deleting a password number.

FIG. 12 is a flow chart of a processing step after registration of a user card.

FIG. 13 a flow chart of a processing step after registration of a password number.

FIG. 14 is a flow chart of a processing step after unlocking.

### SUMMARY

Hereinafter, an embodiment will be described with reference to attached drawings. Also, the attached drawings and disclosure to be described later are an example of this disclosure, and a subject of description of claims thereof is not intended to be limited.

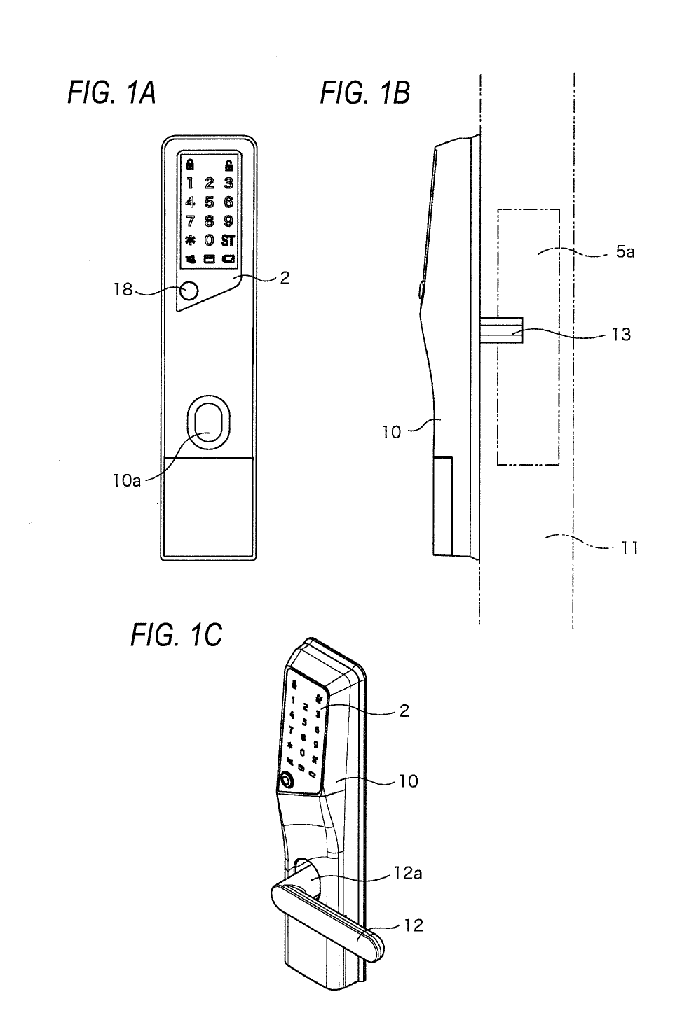

FIG. 1A to FIG. 10 illustrates a lock device for an entrance door, to which an electric lock control device of the embodiment is applied. The lock device of this example is formed by inserting an actuator 5b such as a motor for operating a rim lock 5a inserted into a door 11 and an electric lock control device for controlling motions of an actuator 5b inside a case 10, and is used by being fixed to a surface of an outside wall of the entrance door.

In addition, an operation shaft 12a of a handle 12 is inserted into a through hole 10a provided in the case 10, and a latch (not illustrated) provided in the rim lock 5a is operated.

The password code input section 2 is disposed on an upper portion of the case 10, if authentication with respect to the authentication operation using the password code input section 2 is established, a drive shaft 13 is rotated by the actuator 5b, and the rim lock 5a is locked and unlocked.

Also, regarding an electric lock 5 in the example of

FIG. 1A to FIG. 1C, a case, in which it is configured to have the actuator 5b inside the case 10 and the rim lock 5a inside the door 11, is illustrated. However, in order to control the electric lock 5 in which a lever and the actuator 5b are accommodated in the same case, only a necessary part may be accommodated in the case 10, or an authentication section 14 to be described later may be disposed outside the case 10.

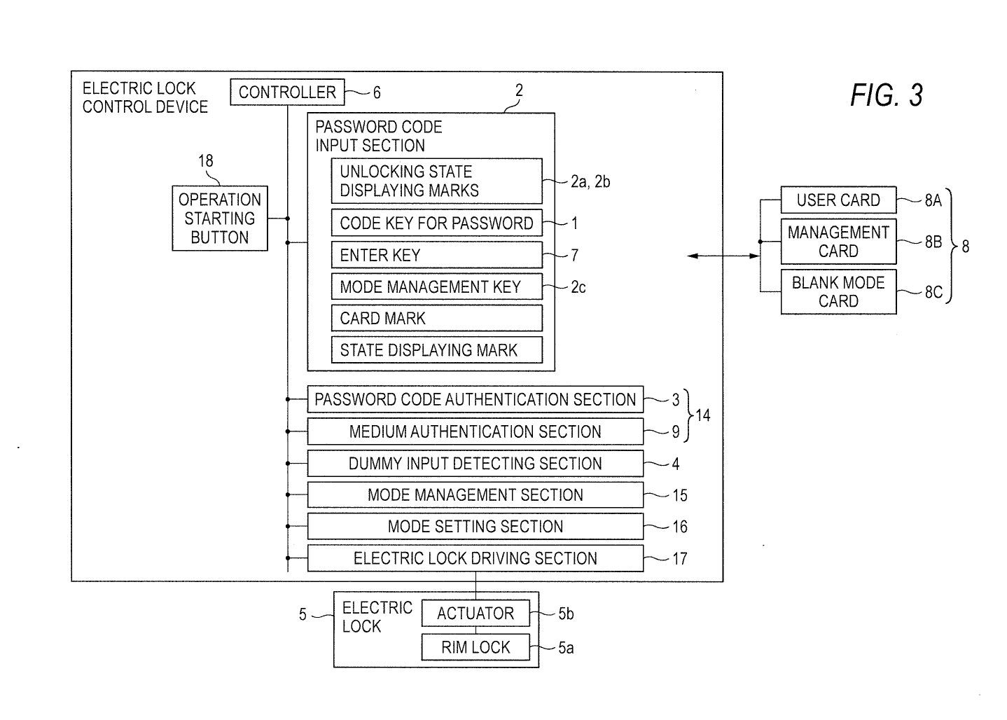

As illustrated in FIG. 3, the electric lock control device includes a controller 6, the password code input section 2 which is controlled and operated by the controller 6, the password code authentication section 3, a medium authentication section 9 which constitutes the authentication section 14 with the password code authentication section 3, a dummy input detecting section 4, a mode management section 15, a mode setting section 16, and an electric lock driving section 17. The actuator 5b inside the electric lock 5 is driven by a locking and unlocking driving signal output from the electric lock driving section 17, and the actuator 5b is transited between locking and unlocking states. In addition, an operation starting button 18, which is for informing a start of use by a user to the device, is disposed in an appropriate position of the device.

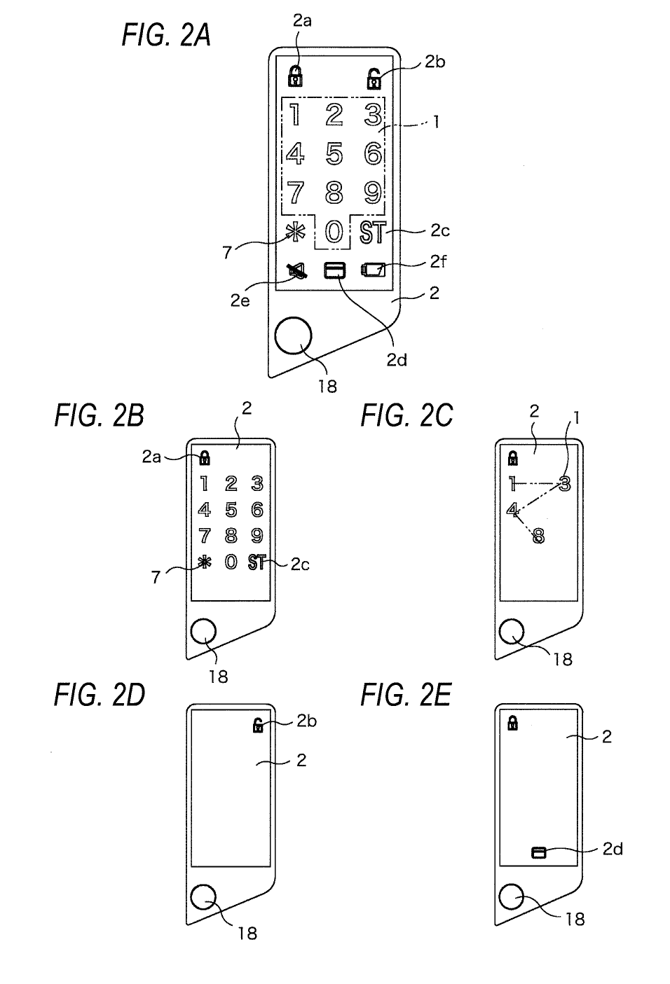

As illustrated in FIG. 2A to FIG. 2E, the password code input section 2 is formed of an electrostatic capacity type touch sensor in which a display is mounted. Locking and unlocking state displaying marks 2a and 2b, code keys for a password (ten keys 1), an enter key 7, a mode management key 2c, a card mark 2d, and alert marks 2e and 2f can be displayed in a predetermined position or in a non-display state by control from the controller 6.

The locking and unlocking state displaying marks 2a and 2b are configured to have the locking state displaying marks 2a displayed when the electric lock 5 enters a locking state and the unlocking state displaying mark 2b displayed when the lock enters an unlocking state. The ten keys 1 is configured to have Arabic numerals from 1 to 0, which are components of a code string for authentication, and these numerals can be input by touching the displayed numerals from the top.

When an authentication method by the password code is selected, first, as illustrated in FIG. 2B, the controller 6 moves a operation mode to the main authentication operation by displaying the entirety of the ten keys 1, if authentication is established with the password code authentication section 3 to be described later, once the entirety of the ten keys 1 is set to the non-displaying state, and then as illustrated in FIG. 2C, the controller 6 displays an appropriate number of keys again and transits to a standby screen of the dummy input.

The enter key 7 is input in order to inform finishing of inputting of a password code string for authentication by the user, and if the controller 6 detects inputting the enter key 7, the input code string is output to the password code authentication section 3 to be described later. The password code string for authenticating in the example has a specification in which the enter key 7 is input after a predetermined number of digits (four digits) from starting of inputting is input;

however, a specification in which four digits are adopted as the password code string for authentication by returning to the enter key 7 can be used.

The mode management key 2c is used to transit management steps such as an initial registration of the password code string for authentication, and regarding the alert marks 2e and 2f, in a case in which a remaining battery level of a mute notifying mark 2e, when operation sound is set in a mute state, is reduced, a battery consumption mark 2f is displayed.

In addition, a reading device that reads the authentication medium 8 (authentication card), which is shaded, is provided on a surface of the password code input section 2 in the case 10, and when an authentication method by the authentication card 8 is selected, a card mark 2d for informing a card readable region is displayed in the password code input section 2.

The password code authentication section 3 determines whether or not a code string input from the password code input section 2 coincides with a password code string for authentication registered in advance, and an authentication establishment signal is output to the controller 6 in a case of coincidence.

The dummy input detecting section 4 determines whether or not the ten keys 1, which are displayed on a dummy input screen continue to the main authentication operation, are input, a dummy input finish signal is output to the controller 6 if the entirety of the displayed code for password 1 is input, and the controller 6, which receives the dummy input finish signal, drives an actuator by setting an actuator driving signal to the electric lock driving section 17, and operates the electric lock 5.

Inputting of the ten keys 1 in the main authentication operation, that is, the authentication operation in the password code authentication section 3 coincides with the password code string for authentication in both of inputting code types and an inputting sequence, and authentication is not established if a different code from password 1 is included. On the other hand, the inputting sequence or mixing of the code for password 1 which is not displayed does not affect determination in the dummy input detecting section 4, and only whether or not the entirety of the displayed code for password 1 becomes criterion for determination. As a result, as illustrated in FIG. 2C by a chain line, the dummy input operation can be performed by a swiping operation when sliding the displayed code for password 1, and in this case, a swiping sequence and path do not matter.

The medium authentication section 9 reads an authentication code, which is maintained in the authentication card 8 owned by a user, by the reading device, and performs authentication determination when coinciding a criteria code registered in a code storing section which is not in drawings, and if the authentication is established, the authentication establishment signal is output to the controller 6, and the controller 6, which receives the authentication establishment signal, drives the actuator by immediately setting the electric lock driving section 17 and operates the electric lock 5, unlike a case of a password code authentication method.

When applying the electric lock control device, in order to perform authentication by the medium authentication section 9, a user card 8A which is used by a user at the time of normally applying the card, a management card 8B for performing registration of the user card 8A, and deleting and changing a password code, and a blank mode card 8C, which is used in a “blank mode” to be described later and is capable of authentication by the medium authentication section 9, are used.

In the electric lock control device, a “medium singularity mode (card singularity mode)” in which only a medium authentication method (card authentication method) of performing authentication using the authentication card 8 is used as a usable authentication method, a “password number singularity mode” in which only the password number authentication method is used, a “card priority mode” in which both of the card authentication method and the password number authentication method can be used as the usable authentication method and the card authentication method is preferentially used, a “password number priority mode” in which both of the card authentication method and the password number authentication method can be used and the password number authentication method is preferentially used, and further, a blank mode described above, are set, and a current applying mode is stored in the mode management section 15 described above.

When a singularity mode and a priority mode are provided, in order to be capable of selecting both of them by preference according to a use circumstance of the user, usability is improved, and since a mode is converted by an instruction operation of the authentication method, the user can reasonably apply without being conscious of an inner mode, or the like, and therefore, usability is improved.

The mode management section 15 manages an execution sequence based on information relating to a stored applying mode, in a case in which a single authentication method is selected as the usable authentication method.

In the example, in a case in which the “card singularity mode”, or the “password number singularity mode” is registered, a use other than a designated mode is prohibited.

With respect to that, in a case in which the priority mode, in the example, the “card priority mode” or the “password number priority mode” is designated, when receiving a use request of the user, first, the authentication method to be prioritized is performed. In a case in which the authentication operation is performed in the authentication method by the user in this state, the authentication operation is complete and moved to an initial state; however, in a case in which the authentication operation is not performed by a priority authentication method, an authentication device is activated in the other authentication methods, and the authentication operation in the authentication method is urged.

Since the priority authentication method can be registered by the user and the priority authentication method registered at the time of use is most preferentially performed, for example, in a case of authentication by a card, a password number inputting screen is displayed by initial setting, an unnecessary skip operation, such as being transited to an authentication screen using the card by skipping, does not need to be performed, and thus usability is good, and power does not need to be supplied to unnecessary authentication means, whereby a power source can also be efficiently used.

The mode setting section 16 is activated in a condition of establishing authentication by the password code authentication section 3 or the medium authentication section 9, the usable authentication method is added by the user, and the mode is automatically changed based on a deleting motion.

In the example, if the user registers the card authentication method under the password number singularity mode, a registering mode in the mode management section 15 is changed to the password number priority mode, and is changed to the card priority mode by registering the password number authentication method. In addition, in a case in which both of a password number method and a card method are deleted from the usable authentication method, the mode is moved to the blank mode, after that, only authentication by the blank mode card 8C can be performed.

The electric lock driving section 17 monitors the electric lock 5 or a locking and unlocking state signal output from the door 11, in a case of receiving a locking state signal, the controller 6 outputs the electric lock 5 by generating a driving signal for unlocking in a condition in which an output condition of a driving signal to the electric lock 5 is satisfied, and drives the electric lock 5 to be unlocked. In addition, in a state in which the unlocking state signal is received, the electric lock driving section 17 checks a current applying mode in the mode management section 15, and in a case of modes other than the card singularity mode, the electric lock 5 is driven to be locked by generating the driving signal for locking when receiving a holding-down signal of the operation starting button 18.

With respect to that, in a case in which the current applying mode is the card singularity mode, authentication of the authentication card 8 is set to a condition at the time of locking, and generating of a lockout state in which the authentication card 8 is left inside and forgotten and locking is performed is prevented.

Also, in the example, a request of locking a holding-down operation of the operation starting button 18 is described; however, without requesting holding-down of the operation starting button 18, the device can be formed to be automatically locked after a predetermined time elapses. Even in this case, under the card singularity mode, the device can be formed to request authentication of the authentication card 8 at the time of automatic locking.

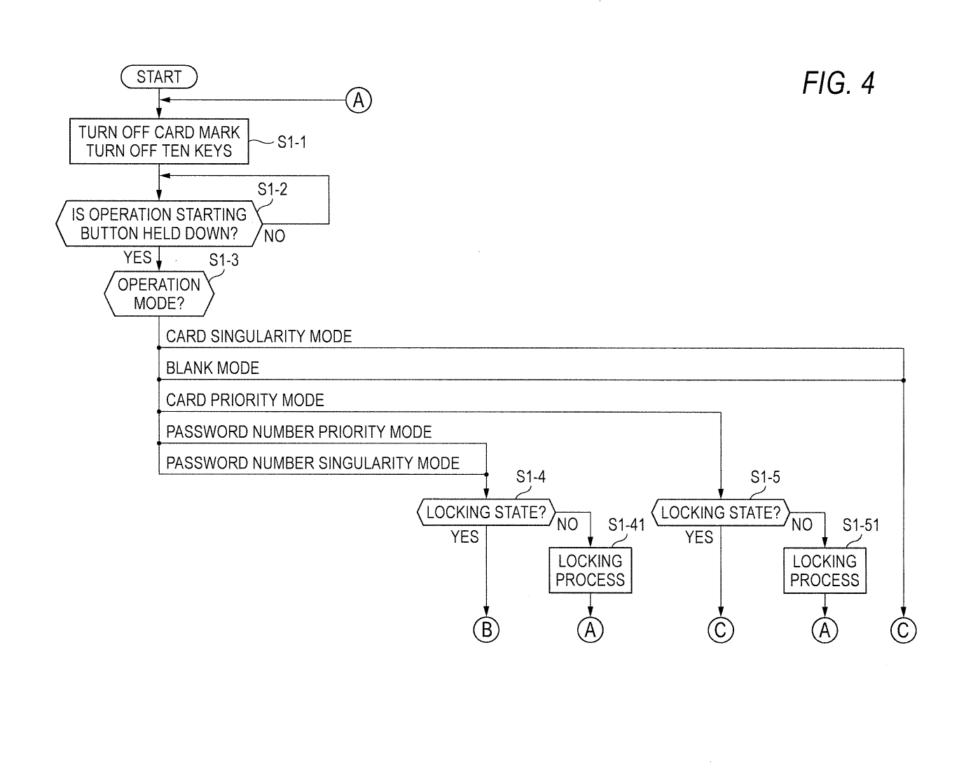

The embodiment is illustrated as motion flow charts from FIG. 4. As illustrated in FIG. 4, if applying is started, various initial settings are read, and operation of the user is waited for in a state in which the card mark and the ten keys 1 are turned off (Step S1-1).

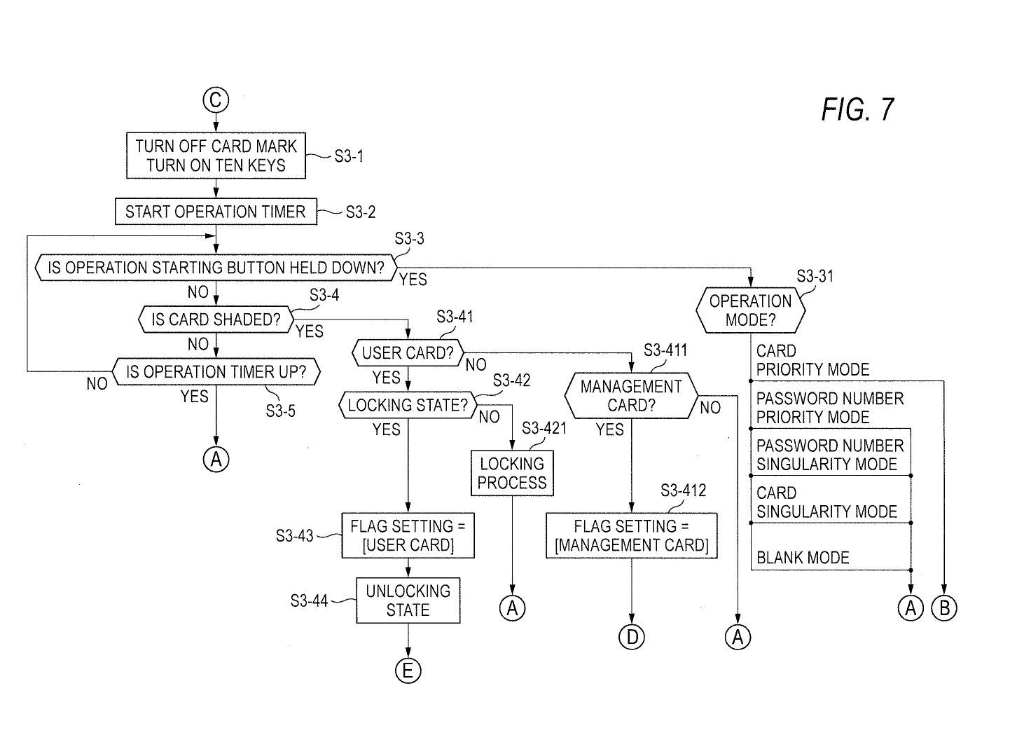

In this state, if the operation starting button 18 is held down by the user (Step S1-2), a process is ramified based on information relating to the current applying mode in the mode management section 15 (Step S1-3), and in a case in which the current applying mode is the card singularity mode or the blank mode, a card authentication step illustrated in FIG. 7 is performed.

With respect to that, in a case in which the card priority mode in Step S1-3 is detected, first, a locking and unlocking signal is checked (Step S1-5), and if an unlocking state signal is detected in Step S1-5, a locking process is performed and the procedure returns to a waiting state (Step S1-51), and if a locking state is detected, the card authentication step is performed in order to authenticate the authentication card 8.

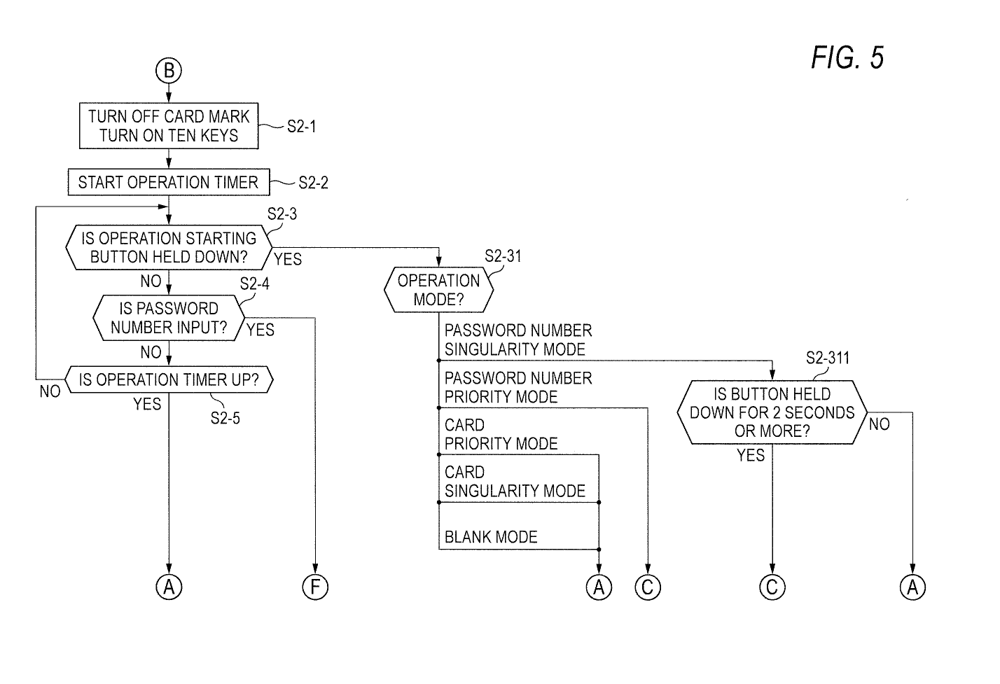

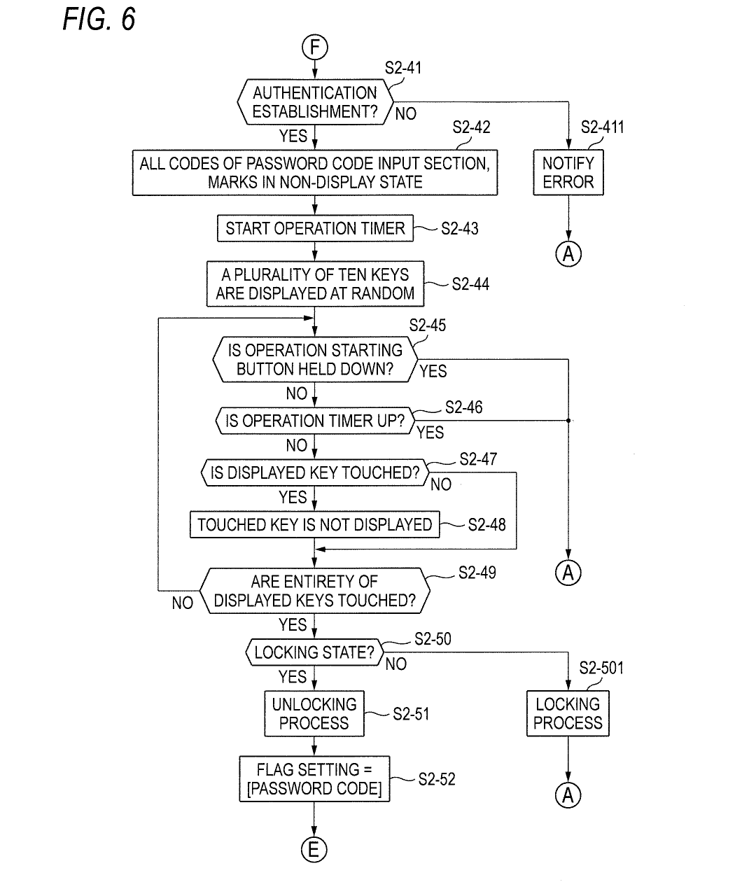

In addition, if the password number priority mode in Step S1-3 or the password number singularity mode is detected, the locking and unlocking signal is checked (Step S1-4), if an unlocking state signal is detected in Step S1-4, the locking process is performed and the procedure returns to a waiting state (Step S1-41), and if the locking state is detected, in order to authenticate the password number, the password number authentication step illustrated in FIGS. 5 and 6 is performed.

In the password number authentication step, first, the ten keys 1 is turned on and the password number is urged to be input, and thus the main authentication operation is started (Step S2-1), subsequently, a motion timer for a measurement time of inputting the password number is started (Step S2-2). During the measurement time by the motion timer, holding-down of the operation starting button 18 (Step S2-3) or inputting of the password number (Step S2-4) is monitored, in a case in which both operations within a timer setting time are not operated (Step S2-5), the state returns to the waiting state.

With respect to that, if the password number is input in Step S2-4 and the enter key 7 is input, as illustrated in FIG. 6, the authentication operation in the password code authentication section 3 is started (Step S2-41), and in a case in which authentication is not established, after an error is notified (Step S2-411), the state returns to the waiting state. If authentication is established in Step S2-41, once all codes and the marks of the password code input section 2 are set in a non-display state (Step S2-42), and then the motion timer is started (Step S2-43), the appropriate number of the ten keys 1 (four digits in the example) are displayed at random and a dummy input stage is started (Step S2-44).

The operation starting button 18 is held down in the dummy input stage (Step S2-45), or in a case in which the dummy input is not started within a predetermined time (Step S2-46), the state returns to the waiting state as a cancel operation.

With respect to that, in a case in which a displayed key is touched in the dummy input stage (Step S2-47), the touched key is not displayed (Step S2-48), and if the entirety of the displayed keys are touched (Step S2-49), it determines whether or not a state is the locking state (Step S2-50), and after performing the locking process at the time of an unlocking state (Step S2-501), the state returns to the waiting state.

In addition, after the unlocking process is performed at the time of the locking state in Step S2-50 (Step S2-51), a “password number” flag is set (Step S2-52), and a step after the unlocking process illustrated in FIG. 14 is performed.

Further, if holding-down of the operation starting button 18 is detected in Step S2-3, the current applying mode is checked (Step S2-31). In the card priority mode in Step S2-31, if the card singularity mode or the blank mode is detected, since these mode cannot become a choice next to a password number mode, the holding-down operation of the operation starting button 18 is interpreted as a returning operation to the initial state, and the state returns to the waiting state.

In addition, in a case in which the password number priority mode is detected in Step S2-31, since the holding-down operation of the operation starting button 18 in Step S2-3 is considered as a skip operation of the password number authentication step, the card authentication step illustrated in FIG. 7 is performed.

Further, in a case in which the password number singularity mode is detected in Step S2-31, since authentication by the management card 8B in the password number singularity mode can be performed, it is determined whether or not a holding-down time of the operation starting button 18 in Step S2-311 exceeds a predetermined time (two seconds in the example), and in a case in which the time is not exceeded, the holding-down operation of the operation starting button 18 is interpreted as the returning operation to the initial state, and the state returns to the waiting state, and in a case in which the time is exceeded, the operation is interpreted as a request of authentication by the management card 8B, and the card authentication step is performed.

In the card authentication step, as illustrated in FIG. 7, first, the card mark is turned on and displayed, and the authentication card 8 is urged to be shaded in the reading section of a card (Step S3-1), and then in order to measure a time for shading the authentication card 8, the motion timer is started (Step S3-2). During measuring using the motion timer, holding-down of the operation starting button 18 (Step S3-3) or reading information relating to the authentication card 8 (Step S3-4) is monitored, and in a case in which both operations are not performed within a timer setting time (Step S3-5), the state returns to the waiting state.

With respect to that, information of the authentication card 8 is input in Step S3-4, and the read authentication card 8 is identified to be the user card 8A or the management card 8B, and if the card is the user card 8A, that is, the user card 8A which can be authenticated correctly (Step S3-41), the locking and unlocking state is detected, and in a case of the unlocking state (Step S3-42), after the locking process is performed (Step S3-421), the state returns to the waiting state.

In Step S3-42 described above, other than the card singularity mode in a starting step of FIG. 4, since the locking process is finished, it functions as an inspection step with the card singularity mode as a target, and as a result, the locking operation in the card singularity mode is required to meet a condition in which authentication is established.

In addition, if the locking state is detected in Step S3-42, after a “user card” flag is set (Step S3-43), the unlocking process is performed (Step S3-44), and the step after the unlocking process illustrated in FIG. 14 is performed.

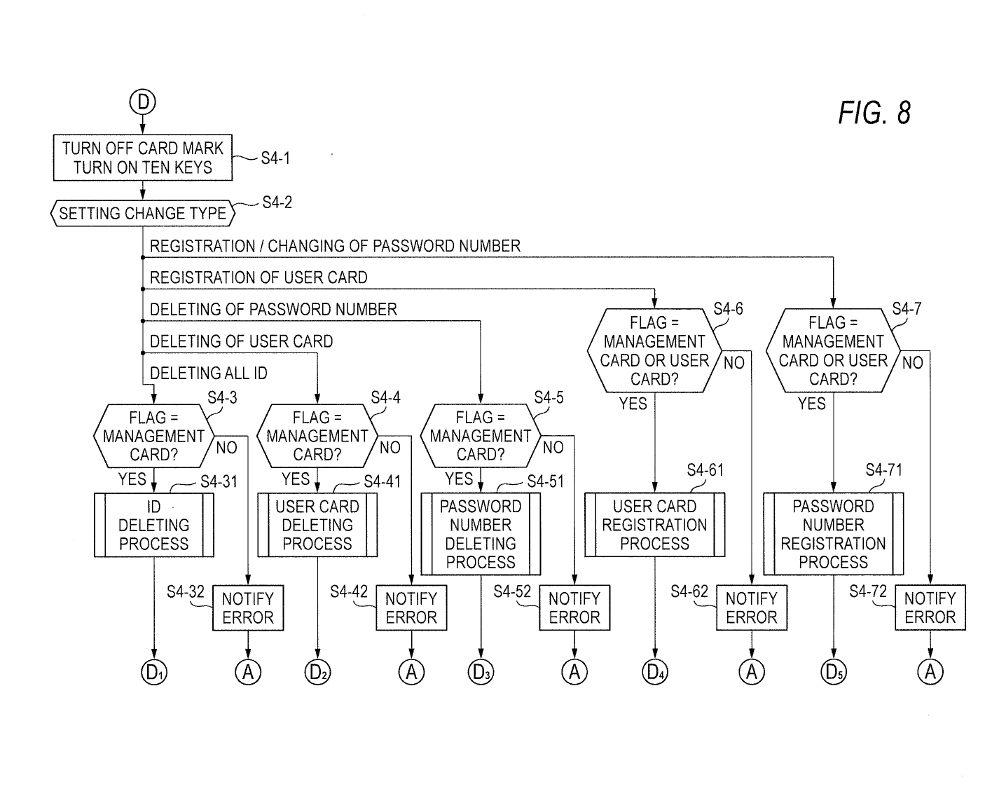

With respect to that, in a case in which the user card 8A is not identified in Step S3-41, first, it is identified whether or not the card is the management card 8B (Step S3-411), and in a case in which the card is not the management card 8B, the state returns to the waiting state, and in a case in which the card is the management card 8B, after a “management card” flag is set (Step S3-412), the management step illustrated in FIG. 8 is performed.

Further, if holding-down of the operation starting button 18 is detected in Step S3-3, the current applying mode is checked (Step S3-31), and in a case in which the applying mode is the card priority mode, a password step is performed, and in the other cases, the holding-down operation of the operation starting button 18 is interpreted as the returning operation to the initial state, and the state returns to the waiting state.

In the management, as illustrated in FIG. 8, first, the ten keys 1 are turned on (Step S4-1), and a management type is urged to be specified (Step S4-2). Mode management is automatically determined by an ID registration and deleting operation.

An authorization of the ID deleting operation is given to only performing of the management step in which the management card 8B is used, and in a case of requesting of a deleting operation of the ID in which the management card 8B is not used (Steps S4-3, 4, and 5), after an error is notified (Steps S4-32, 42, and 52), the state returns to the waiting state.

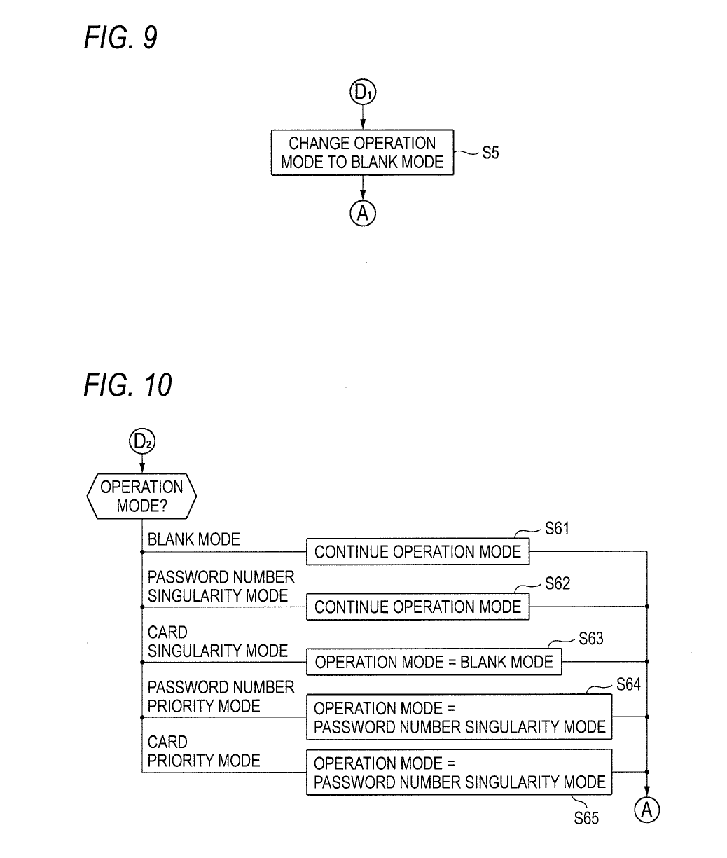

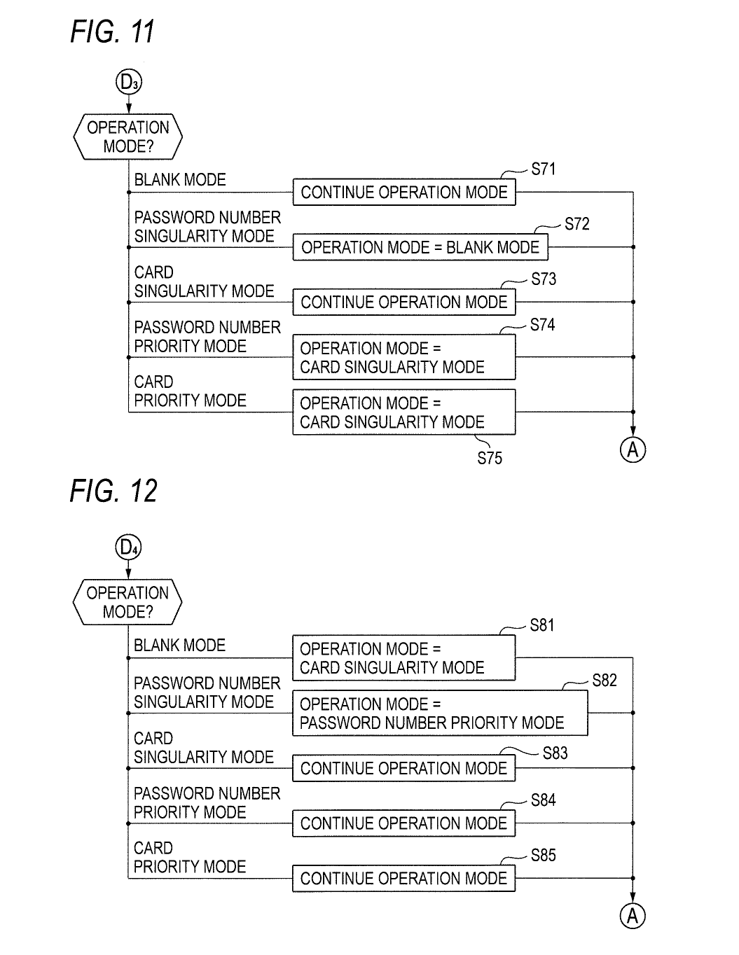

With respect to that, in a case in which setting change types is the password number and a request for deleting the authentication card 8, after an ID deleting process is performed (Step S4-31), as illustrated in FIG. 9, after the motion mode is changed into the blank mode (Step S5), the state returns to the waiting state. In addition, respectively, in a case in which there is a request of deleting the user card 8A in Step S4-2, after a deleting process of the user card is performed (Step S4-41), a process step after deleting the user card illustrated in FIG. 10 is performed, and in a case in which the password number is requested to be deleted, after a password number deleting process is performed (Step S4-51), a process step after deleting the password number illustrated in FIG. 11 is performed.

In addition, in a case in which registration of the user card 8A in which a process by the user card 8A is permitted, or registration and changing of the password number are requested in Step S4-2, it is determined whether or not the card is the user card 8A or the management card 8B (Steps S4-6 and 7), and after an error is notified in a case in which the card is not any of them (Steps S4-62 and 72), the state returns to the waiting state.

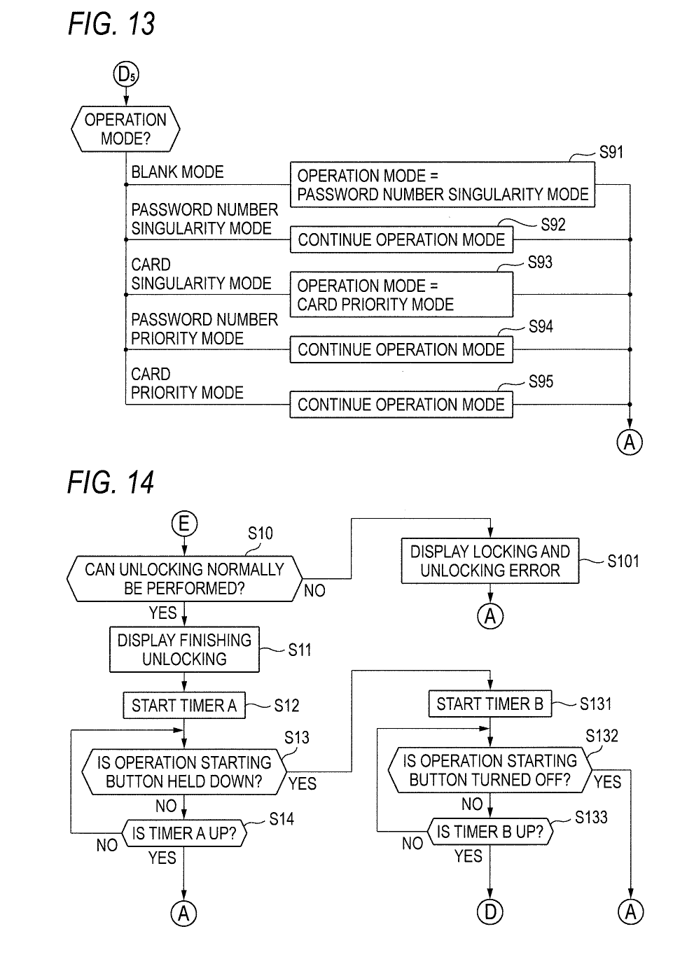

Further, in a case in which a registration process request of the user card 8A is performed by the management card 8B or the user card 8A in Step S4-2, after the registration process of the user card 8A is performed (Step S4-61), a process step after registering the user card 8A illustrated in FIG. 12 is performed, and in a case in which a registration process request of the password number is performed, after the registration process of the password number is performed (Step S4-71), a process step after registering the password number illustrated in FIG. 13 is performed.

When changing a mode in a process step after deleting the user card 8A, as illustrated in FIG. 10, in a case in which a mode currently performed is the blank mode or the password number singularity mode, since an authentication circumstance is not changed by deleting the user card 8A, the motion mode is maintained and continued (Steps S61 and 62), and in a case in which the mode is the card singularity mode, the mode is moved to the blank mode in which accessing by the authentication card 8 is limited to a use of the management card 8B and a blank card (Step S63), and the state returns to the waiting state.

In addition, in a case in which a step being performed in the process step after deleting the user card is the password number priority mode, since the card authentication method which is a switching target is deleted, the mode is moved to the password number singularity mode (Step S64), and then the state returns to the waiting state, and in a case of the card priority mode, the mode moves to the password number singularity mode (Step S65), and then the state returns to the waiting state.

Further, when changing a mode in the process step after deleting the password number, as illustrated in FIG. 11, in a case in which a mode currently performed is the blank mode or the card singularity mode, since an authentication circumstance is not changed by deleting the password number, the motion mode is maintained and continued (Steps S71 and 73), and in a case in which the mode is the password number singularity mode, the mode is moved to the blank mode (Step S72), and the state returns to the waiting state.

In addition, in a case in which a step being performed in the process step after deleting the password number is the password number priority mode, the mode is moved to the card singularity mode (Step S74), and in a case in which the mode is the card priority mode, the password number authentication method which is a switching target is deleted, the mode is changed to the card singularity mode (Step S75), and then the state returns to the waiting state.

When changing a mode in a process step after registering the user card, as illustrated in FIG. 12, in a case in which a mode currently performed is the card singularity mode, the password number priority mode, or the card priority mode, since an authentication circumstance is not changed by registering the user card 8A, the motion mode is maintained and continued (Steps S83, 84, and 85).

In addition, in a case in which a mode currently performed is the blank mode, the mode is changed to the card singularity mode by registering the user card 8A (Step S81), and then the state returns to the waiting state, and in a case in which the mode is the password number singularity mode, the mode is changed to the priority mode in which the previous password number authentication method is preferentially displayed, that is, the password number priority mode (Step S82), and then the state returns to the waiting state.

FIG. 13 illustrates changing a mode in the process step after registering the password number, in a case in which a mode currently performed is the password number singularity mode, the password number priority mode, or the card priority mode, since an authentication circumstance is not changed by registering the password number, the motion mode is maintained and continued (Steps S92, 94, and 95). In addition, in a case in which a mode currently performed is the blank mode, the mode is changed to the password number singularity mode by registering the password number (Step S91), and then the state returns to the waiting state, and in a case in which the mode is the card singularity mode, the mode is changed to the priority mode in which the previous card authentication method is preferentially displayed, that is, the card priority mode (Step S93), and then the state returns to the waiting state.

Meanwhile, as illustrated in FIG. 14, first, in the step after the unlocking process, it is determined whether or not the unlocking motion is normally performed (Step S10), and in a case in which performing of the normal operation is not checked, a locking and unlocking error is displayed (Step S101), and then the state returns to the waiting state.

With respect to that, in a case in which a normal unlocking motion is checked in Step S10, displaying of unlocking completion is performed (Step S11), and then a moving operation to the management step can be performed. In a movement to the management step, after the unlocking motion, the operation starting button 18 is held down within a predetermined time, and the operation starting button 18 is held down at a constant time as it is, in order to detect the operation, first, the timer A is activated (Step S12), and in a case in which the operation is not performed within a predetermined time (Step S14), the state returns to the waiting state.

Meanwhile, in a case in which the holding-down operation of the operation starting button 18 is performed before the timer A is up (Step S13), a timer B is started (Step S131), if it is detected that a predetermined time elapses (Step S133), a step is moved to the management step, and if the holding-down operation of the operation starting button 18 is stopped before the time elapses (Step S132), the state returns to the waiting state.

The electric lock control device of this disclosure is provided with the password code input section 2 in which different codes for password 1 are disposed in an arrangement set in advance, the password code authentication section 3 in which an authentication establishment condition is that the input code string input from the password code input section 2 coincides with the pre-registered password code string for authentication, the dummy input detecting section 4 which detects an input of an arbitrary code for password 1 to the password code input section 2 after the main authentication operation in the password code authentication section 3, and the controller 6 which drives the electric lock 5 to unlock in a condition of detecting an input of the code for password 1 in the dummy input detecting section 4 in addition to the authentication establishment at the time of the main authentication operation.

In the electric lock control device, continuing to the main authentication operation in which the password code string for authenticating is input to the password code input section 2, when setting an input of dummy codes not being used for authentication to the password code input section 2 as a driving condition of the electric lock 5, the main authentication operation is performed, and then only a fingerprint indicating the password code string for authentication does not remain in the password code input section 2.

As a result, the password code string for authentication is not able to be estimated by monitoring the password code input section 2 after using the electric lock control device, and in the password code input section 2, the code for password 1 is always disposed in the same arrangement, and thus a look-up operation of a position of the code for a password generated in a case in which the position is different in each authentication operation is not necessary, and therefore, usability is improved.

In the electric lock control device of this disclosure, an enter key 7 may be disposed in the password code input section 2, and arbitrary numbers before inputting the enter key 7 may be adopted as the password code string for authentication in the main authentication operation.

When finishing the main authentication operation, it is efficient if the controller 6 accumulates input codes until input digits in an input mode of the main authentication operation reach a predetermined digit and notifies the codes to the password code authentication section 3 as the password code string for authenticating, so that a specific enter key 7 does not need to be set; however, if the enter key 7 is set, transiting to the dummy input operation can be informed to a user, and thus an error-input by misunderstanding, or the like can be prevented.

In addition, if the enter key 7 is set, dummy codes which are not used for authentication can be input to initial appropriate numbers, and leaking of the password code string for authentication by spying at the time of inputting can be prevented. In this case, the controller 6 may extract only inputting codes of predetermined digits prior to the enter key 7 and notify them to the password code authentication section 3.

In the electric lock control device of this disclosure, the password code input section 2 may display the code for password 1 to be able to be transited to a non-display state and display the arbitrary numbers of the code for password 1 as codes for dummy input at the time of a dummy input operation, and the dummy input operation may be completed by selecting the entirety of displayed codes for dummy input.

Input codes for a dummy can be selected freely by the user each time; however, if the appropriate code for password 1 is configured to be displayed at the time of the dummy input, the user does not hesitate, and if the code for password 1 is appropriately disposed, the user can be instructed to input a code with a wide range of the password code input section 2, there are lots of the codes to which a fingerprint, or the like is attached, and the password code for authentication is further difficult to be estimated.

In the electric lock control device of this disclosure, the password code input section 2 may be formed by a capacitance type touch sensor and the dummy input to the password code input section 2 may be able to be performed by a swiping operation.

The dummy input is sufficient by only instructing a predetermined position; however, a surface of the password code input section 2 is traced by a finger when the password code input section 2 is formed to have the capacitance type touch sensor, so that a so called swiping operation can be performed, instruction traces on the password code input section 2 can be aggressively deleted.

In the electric lock control device of this disclosure, the electric lock control device may include the medium authentication section 9 which authenticates an electronic authentication code maintained in the authentication medium 8 instead of the password code authentication section 3 when being selected by a user, wherein an authentication code readable region of the authentication medium 8 may be set in a part of the password code input section 2, and the controller 6 may display the authentication code readable region on the password code input section 2 instead of the code for password 1 at the time of selecting an authentication method by the medium authentication section 9.

In the electric lock control device of this disclosure, any one of the authentication method by the password code authentication section 3 and the authentication method in the medium authentication section may be able to be registered as the priority authentication method, and the controller 6 may firstly perform the priority authentication method at the time of activation.

According to the example of this disclosure, in the electric lock control device including the authentication section, which includes a plurality of authentication methods which is able to be switched, and driving the device to unlock the electric lock 5 in a condition of the authentication establishment in the authentication section, the priority authentication method may be able to be registered by the user, and the registered priority authentication method may be firstly performed when using the authentication section.

The electric lock control device of this disclosure may include the priority mode, in which any one of the selected plurality of authentication methods as the usable authentication method by the user from the plurality of the authentication methods is designated as the priority authentication method, and the singularity mode, in which any one of the authentication methods of the arbitrary numbers is selected as the usable authentication method by the user, and a mode may be automatically changed to the priority mode by registering the other authentication methods after the authentication establishment in the singularity mode.

In the electric lock control device of this disclosure, the medium authentication method of authentication with respect to the electronic authentication code maintained in the authentication medium 8 may be included as the usable authentication method, the locking operation may be able to be performed without requesting the authentication operation other than the medium singularity mode in which only a method of the authentication medium 8 can be used, and in the medium singularity mode, the authentication establishment by the authentication medium 8 may be a condition of performing the locking operation.

In the electric lock control device of this disclosure, a mode may be automatically transited to the priority mode, in which the usable authentication method at the time of the singularity mode is set to the priority authentication method, by registering the other authentication methods in the singularity mode.

In the electric lock control device of this disclosure, the blank mode, in which the authentication operation may be able to be performed when the usable authentication method is not determined by the user, which is performed by entirely deleting the usable authentication method, may be included, and the mode may be automatically transited to the singularity mode by registering the usable authentication method after authentication in the blank mode.

According to the electronic lock control device of this disclosure, leaking of the password code can be reliably prevented according to inputting of the password code.

### REFERENCE SIGNS LIST

1 code for password
2 password code input section
3 password code authentication section
4 dummy input detecting section
5 electric lock
6 controller
7 enter key
8 authentication medium
9 medium authentication section

What is claimed is:

1. An electric lock control device comprising:
a password code input section in which different codes for password are disposed in an arrangement set in advance;
a password code authentication section in which an authentication establishment condition is that an input code string input from the password code input section coincides with a pre-registered password code string for authentication;
a dummy input detecting section which detects an input of an arbitrary code for password to the password code input section after a main authentication operation in the password code authentication section; and
a controller which drives an electric lock to unlock in a condition of detecting an input of a code for password in the dummy input detecting section in addition to the authentication establishment at the time of the main authentication operation.

2. The electric lock control device according to claim 1, wherein an enter key is disposed in the password code input section, and arbitrary numbers before inputting the enter key is adopted as a password code string for authentication in the main authentication operation.

3. The electric lock control device according to claim 1, wherein the password code input section displays the code for password to be able to be transited to a non-display state, and
wherein the password code input section displays the arbitrary numbers of the code for password as codes for dummy input at the time of a dummy input operation and the dummy input operation is completed by selecting the entirety of displayed codes for dummy input.

4. The electric lock control device according to claim 1, wherein the password code input section is formed by a capacitance type touch sensor and the dummy input to the password code input section is able to be performed by a swiping operation.

5. The electric lock control device according to claim 1, wherein the electric lock control device is provided with a medium authentication section which authenticates an electronic authentication code maintained in an authentication medium instead of the password code authentication section when being selected by a user, and
wherein an authentication code readable region of the authentication medium is set in a part of the password code input section, and the controller displays the authentication code readable region on the password code input section instead of the code for password at the time of selecting an authentication method by the medium authentication section.

6. The electric lock control device according to claim 5, wherein any one of an authentication method by the password code authentication section and the authentication method by the medium authentication section is able to be registered as a priority authentication method, and the controller firstly perform the priority authentication method at the time of activation.
